(19) United States
(12) Patent Application Publication
(10) Pub. No.: US 2026/0238730 A1
(43) Pub. Date: Aug. 13, 2026

(54) IMAGE READING DEVICE AND IMAGE READING DEVICE CONTROL METHOD

(71) Applicant: SEIKO EPSON CORPORATION, TOKYO (JP)

(72) Inventors: Etsuya MATSUYAMA, KITAKYUSHU-SHI (JP); Yoshihiro HAMAGUCHI, KITAKYUSHU-SHI (JP); Hiroki MATSUDA, KITAKYUSHU-SHI (JP)

(21) Appl. No.: 19/535,237

(22) Filed: Feb. 10, 2026

(30) Foreign Application Priority Data
Feb. 10, 2025 (JP) 2025-019838

(51) Int. Cl. H04N 1/00

(52) U.S. Cl. CPC H04N 1/00689; H04N 1/00037; H04N 1/00694

(57) ABSTRACT

The image reading device includes a sheet feed tray on which a document is placed; a transport section configured to transport the document from the sheet feed tray; a document base on which the document is placed; a reading section configured to read the document; and a control section. The control section can re-executes a reading mode setting process for selecting one of a plurality of reading modes, including: a first reading mode in which a reading continuation instruction is receivable from the user after the reading section has read the document; and a second reading mode in which a reading continuation instruction is not accepted from the user after the reading section has read the document. The reading mode set in the reading mode setting process is maintained even when a paper jam of the document is detected and subsequently resolved a paper jam of the document.

The present application is based on, and claims priority from JP Application Serial Number 2025-019838, filed February 10, 2025, the disclosure of which is hereby incorporated by reference herein in its entirety.

### BACKGROUND

### Technical Field

The present disclosure relates to an image reading device and an image reading device control method.

### Related Art

For example, JP-A-2018-37899 discloses an image reading device including an image reading section that reads an image of either a document transported from a document tray or a document placed on a contact glass. In the image reading device, the occurrence of a paper jam of a document transported from a document tray is detected by a jam detection section.

In such an image reading device, a continuous reading mode, which is an example of a first reading mode, and a normal reading mode, which is an example of a second reading mode, can be switched. The continuous reading mode is a mode in which image data is stored in the storage section by a plurality of reading instructions. The normal reading mode is a mode in which image data is stored in the storage section by a single reading instruction.

However, in such an image reading device, when a paper jam of a document is detected, the second reading mode is switched to the first reading mode regardless of the intention of the user when the paper jam of the document is resolved. Therefore, there is a possibility that the convenience of the user is reduced.

### SUMMARY

In order to overcome the above concern, an image reading device includes a sheet feed tray on which a document is placed; a transport section configured to transport the document from the sheet feed tray; a document base on which the document is placed; a reading section configured to read the document; and a control section, wherein the control section executes a reading mode setting process that sets one of a plurality of reading modes, the reading modes including a first reading mode in which a reading continuation instruction is receivable from a user after the reading section has read the document and a second reading mode in which a reading continuation instruction is not accepted from the user after the reading section has read the document, a reading target determination process for determining whether a document placed on the sheet feed tray is a reading target or a document placed on the document base is the reading target, a document reading process for, based on a reading start instruction from a user, causing the reading section to read the document that was determined to be the reading target in the reading target determination process, and a paper jam determination process for determining a paper jam of the document transported from the sheet feed tray by the transport section, when a paper jam of a document is determined in the paper jam determination process and the paper jam of the document is subsequently resolved, the document reading process is executable again based on a re-read instruction from a user, and the reading mode set in the reading mode setting process is maintained after the paper jam of the document is determined in the paper jam determination process.

An image reading device control method which solves the above problem is a control method for an image reading device including a reading section configured to read either a document conveyed from a sheet feed tray or a document placed on a document base, the image reading device control method including a reading mode setting process for selecting one of a plurality of reading modes, the reading modes including a first reading mode in which a reading continuation instruction is receivable from a user after the reading section has read the document and a second reading mode in which a reading continuation instruction is not accepted from the user after the reading section has read the document; a reading target determination process for determining whether a document placed on the sheet feed tray is the reading target or a document placed on the document base is the reading target; a document reading process for, based on a reading start instruction from a user, causing the reading section to read the document determined to be the reading target in the reading target determination process; and a paper jam determination process for determining a paper jam of the document transported from the sheet feed tray, wherein the document reading process is a process that is re-executable in a case where a paper jam of a document is determined in the paper jam determination process and the paper jam of the document is subsequently resolved and the reading mode set in the reading mode setting process is maintained after the paper jam of the document is determined in the paper jam determination process.

### BRIEF DESCRIPTION OF THE DRAWINGS

FIG. 1 is a perspective view illustrating a multifunction device according to a first embodiment.

FIG. 2 is a perspective view illustrating the image reading device according to the first embodiment.

FIG. 3 is a block diagram illustrating an electrical configuration of the multifunction device according to the first embodiment.

FIG. 4 is a flowchart illustrating a reading mode setting process according to the first embodiment.

FIG. 5 is a flowchart illustrating an output mode setting process according to the first embodiment.

FIG. 6 is a flowchart illustrating a reading control process according to the first embodiment.

FIG. 7 is a flowchart illustrating a reading control process according to the first embodiment.

FIG. 8 is a flowchart illustrating a reading target determination process according to the first embodiment.

FIG. 9 is a schematic diagram illustrating a re-read image according to the first embodiment.

FIG. 10 is a flowchart illustrating a reading target determination process according to the second embodiment.

FIG. 11 is a flowchart illustrating a second reading control process according to the third embodiment.

FIG. 12 is a schematic diagram illustrating a placement notification image according to the third embodiment.

FIG. 13 is a schematic diagram illustrating an order adjustment image according to the third embodiment.

FIG. 14 is a flowchart illustrating a second reading control process according to the fourth embodiment.

FIG. 15 is a flowchart illustrating a second reading control process according to the fifth embodiment.

### DESCRIPTION OF EMBODIMENTS

### First Embodiment

Hereinafter, an embodiment of an image reading device and an image reading device control method will be described. The image reading device according to the present embodiment may be, for example, a flatbed type scanner device constituting a part of a multifunction device.

In the following description, a direction intersecting the vertical direction Z is referred to as a front-rear direction Y, and a direction intersecting the vertical direction Z and the front-rear direction Y is referred to as an intersecting direction X. One direction along the front-rear direction Y is referred to as the front direction Y1, and the other direction along the front-rear direction Y is referred to as the rear direction Y2. One direction along the intersecting direction X is defined as a first intersecting direction X1, and the other direction along the intersecting direction X is defined as a second intersecting direction X2. An upward direction in the vertical direction Z is defined as an upward direction Z1, and a downward direction in the vertical direction Z is defined as a downward direction Z2.

### Configuration of multifunction device 11

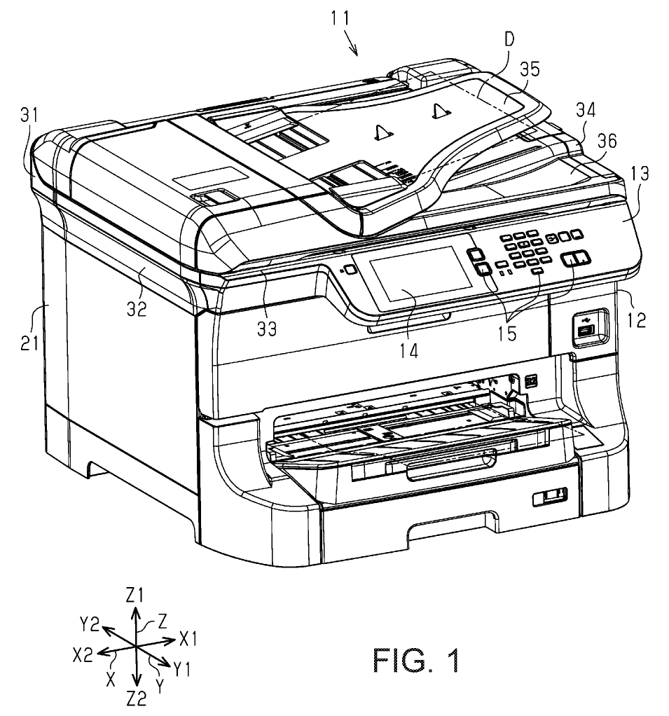

As illustrated in FIG. 1, a multifunction device 11 has functions of printing, scanning, and copying. The multifunction device 11 includes a device main body 12, a printing device 21, and an image reading device 31. The device main body 12 includes an operation panel 13. The operation panel 13 includes a display section 14 and an operation section 15. The display section 14 displays various types of information. The display section 14 may be a touch panel. The operation section 15 can be operated by a user. The multifunction device 11 receives an instruction from the user through the operation section 15. The multifunction device 11 may be capable of communicating with a terminal device (not illustrated.) The multifunction device 11 may display various types of information on the terminal device. The multifunction device 11 may receive an instruction from the user via the terminal device. The operation panel 13 may be provided in the image reading device 31.

### Configuration of image reading device 31

The image reading device 31 captures a document D. The document D may be, for example, a paper sheet. The image reading device 31 is provided on the upward direction Z1 of the printing device 21. The image reading device 31 is a flatbed (FB) type capable of fixing the document D.

The image reading device 31 includes a main body section 32 and a document base cover 34. The main body section 32 includes a document base 33. That is, the image reading device 31 includes the document base 33. The document base 33 is provided on the upper portion of the main body section 32. The document base 33 includes a region on which the document D can be placed. In this manner, the document D can be placed on the document base 33.

The document base cover 34 is provided on an upward direction Z1 of the main body section 32. The document base cover 34 is configured to open and close the document base 33. The document base cover 34 is configured to cover the document base 33. The document base cover 34 includes a sheet feed tray 35 and a discharge tray 36. That is, the image reading device 31 includes the sheet feed tray 35 and the discharge tray 36. The sheet feed tray 35 is capable of having placed thereon a plurality of documents D before reading. The discharge tray 36 is capable of having placed thereon the document D after reading. The read document D is sequentially discharged to the discharge tray 36.

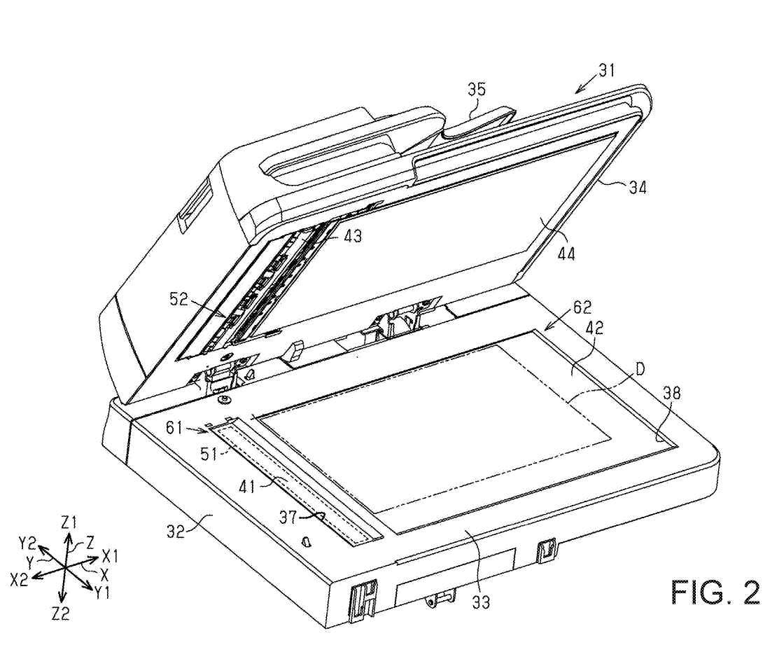

As illustrated in FIG. 2, the main body section 32 includes a first reading window 37 and a second reading window 38. That is, the image reading device 31 includes the first reading window 37 and the second reading window 38. The first reading window 37 and the second reading window 38 are provided on the top face of the document base 33. The first reading window 37 and the second reading window 38 are open toward the upward direction Z1.

The first reading window 37 is provided in a first reading region 61. The first reading region 61 is a region for reading the document D transported from the sheet feed tray 35. The first reading window 37 extends in the front-rear direction Y. The first reading window 37 is slightly longer than the maximum document width in the front-rear direction Y. The first reading window 37 has a length in the intersecting direction X shorter than a length in the front-rear direction Y.

The second reading window 38 is provided in a second reading region 62. The second reading region 62 is a region for reading the document D placed on the document base 33. The second reading window 38 is provided in the first intersecting direction X1 relative to the first reading window 37. The second reading window 38 is slightly wider than the maximum document size that can be read by the image reading device 31. The second reading window 38 is wider than the first reading window 37.

The main body section 32 includes a first translucent component 41 and a second translucent component 42. The first translucent component 41 and the second translucent component 42 are members having light-transmissive properties. The first translucent component 41 and the second translucent component 42 are, for example, transparent glass, but may be a transparent resin material or a transparent ceramic material other than glass.

The first translucent component 41 is provided in the first reading window 37. The first translucent component 41 is fitted in the first reading window 37. That is, the first translucent component 41 is provided in the first reading region 61.

The second translucent component 42 is provided in the second reading window 38. The second translucent component 42 is fitted in the second reading window 38. That is, the second translucent component 42 is provided in the second reading region 62. The second translucent component 42 is a placement section on which the document D can be placed.

The document base cover 34 includes a first backing plate 43 and a second backing plate 44. The first backing plate 43 and the second backing plate 44 are provided in the downward direction Z2 from the document base cover 34 in a state where the document base cover 34 closes the main body section 32. The first backing plate 43 and the second backing plate 44 reflect irradiated light. The first backing plate 43 and the second backing plate 44 are captured as a background together with the document D.

The first backing plate 43 is provided at a position facing the first translucent component 41 in a state where the document base cover 34 closes the main body section 32. That is, the first backing plate 43 is provided in the first reading region 61. The first backing plate 43 is provided at a position where the first translucent component 41 is interposed between the first backing plate 43 and a reading section 51 (to be described later).

The second backing plate 44 is provided at a position facing the second translucent component 42 in a state where the document base cover 34 closes the main body section 32. That is, the second backing plate 44 is provided in the second reading region 62. The second backing plate 44 is provided at a position where the second translucent component 42 is interposed between the second backing plate 44 and the reading section 51 that moves along the intersecting direction X (to be described later).

The main body section 32 includes the reading section 51. That is, the image reading device 31 includes the reading section 51. The reading section 51 is located below the first translucent component 41 in the downward direction Z2. The reading section 51 is configured to extend in the front-rear direction Y. The reading section 51 is mounted on a carriage (not illustrated). The carriage is movable along the intersecting direction X. That is, the reading section 51 is movable along the intersecting direction X. The reading section 51 is movable to a downward direction Z2 of the second translucent component 42.

The reading section 51 is configured to read the document D. The reading section 51 is configured to read an image from the document D. The reading section 51 includes, for example, a light source and a plurality of image sensors. The light source irradiates the document D with light. The light source may be, for example, an LED, a fluorescent lamp, or the like. The plurality of image sensors is arranged in the front-rear direction Y. The image sensor outputs an output value corresponding to the amount of received light. The image sensor may be a monochrome sensor or a color sensor. The image sensor may be, for example, a charge coupled device (CCD) image sensor or a complementary metal-oxide-semiconductor (CMOS) image sensor.

The document base cover 34 includes a transport section 52. That is, the image reading device 31 includes the transport section 52. The transport section 52 is configured to transport the document D from the sheet feed tray 35. The transport section 52 is configured to transport the document D placed on the sheet feed tray 35 to the discharge tray 36 along the transport path. The transport path passes through the first reading region 61. The transport section 52 constitutes a part of an auto document feeder (ADF).

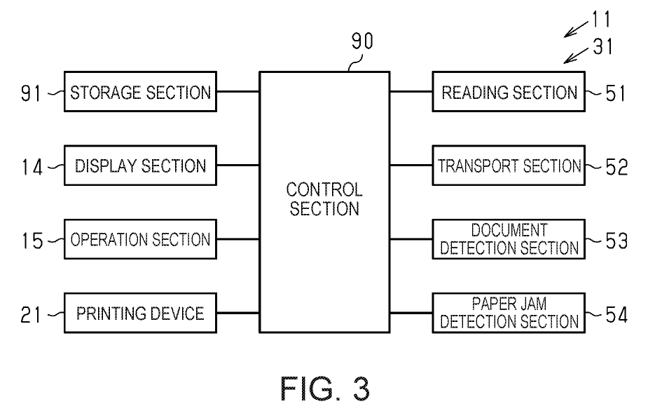

As illustrated in FIG. 3, the image reading device 31 includes a control section 90. The control section 90 may be provided in the main body section 32. The control section 90 comprehensively controls the image reading device 31. The control section 90 controls various operations executed by the image reading device 31.

In this manner, the control section 90 controls the reading section 51 and the transport section 52. The control section 90 causes the display section 14 to display various types of information. The control section 90 can receive an operation signal from the display section 14. The control section 90 can receive an operation signal from the operation section 15. The control section 90 performs control based on detection signals from a document detection section 53 and a paper jam detection section 54 (to be described later). The control section 90 may comprehensively control the device main body 12 and the printing device 21.

The control section 90 may be constituted by one or more processors that execute various processes in accordance with a computer program. The control section 90 may be configured by one or more dedicated hardware circuits such as an application specific integrated circuit that executes at least a part of the various processes. The control section 90 may be configured by a circuit including a combination of a processor and a hardware circuit. The processor includes a CPU and memory such as a RAM and a ROM. The memory stores program code or commands configured to cause the CPU to perform processes. Memory, that is computer-readable medium, includes any readable medium that can be accessed by a general-purpose or dedicated computer.

The image reading device 31 includes a storage section 91. The storage section 91 stores a program executed by the control section 90. The storage section 91 stores data set by the control section 90. The storage section 91 may be configured by a hard disk, a flash memory, or the like. The storage section 91 may be configured by a RAM. The storage section 91 may be included in the control section 90.

The control section 90 determines whether or not the document D is present on the document base 33 based on the image read by the reading section 51. Specifically, the control section 90 moves the reading section 51 over a predetermined distance along the intersecting direction X and causes the reading section 51 to read an image. When the image read by the reading section 51 includes an image different from the second backing plate 44, the control section 90 determines that the document D is present on the document base 33. When the image read by the reading section 51 does not include an image different from the second backing plate 44, the control section 90 determines that the document D is not present on the document base 33. In this manner, the reading section 51 can detect the document D placed on the document base 33.

The image reading device 31 includes the document detection section 53. The document detection section 53 is configured to detect the document D placed on the sheet feed tray 35. The document detection section 53 is configured to detect whether or not the document D is placed on the sheet feed tray 35.

The image reading device 31 includes the paper jam detection section 54. The paper jam detection section 54 is configured to detect a paper jam of the document D transported from the sheet feed tray 35. The paper jam detection section 54 may be provided at a position along the transport path. The paper jam detection section 54 may detect a paper jam of the document D by detecting the document D that leaves the transport path.

The image reading device 31 operates to read an image from the document D based on the input of the reading job. The reading job is input by a reading start instruction from the user. The reading job is input by a reading continuation instruction from a user (to be described later). The reading job may be input in accordance with an operation of the operation section 15. The reading job may be input from a terminal device. The reading job is a process for reading images from one or a plurality of documents D.

The image reading device 31 is operable in any one of a plurality of reading modes. The plurality of reading modes includes a first reading mode and a second reading mode. The first reading mode is a reading mode in which a reading continuation instruction can be received from the user after the reading section 51 is caused to read the document D. Specifically, the first reading mode is a reading mode in which a reading continuation instruction can be received from the user after a reading job is completed based on a reading start instruction from the user. The first reading mode is a reading mode in which a reading continuation instruction from the user can be received again after the reading job is completed based on the reading continuation instruction from the user. That is, the first reading mode is a reading mode in which a re-read job can be received again after the reading job is ended.

The second reading mode is a reading mode in which a reading continuation instruction is not received from the user after the reading section 51 is caused to read the document D. Specifically, the second reading mode is a reading mode in which a reading continuation instruction is not received from the user after the reading job is completed based on the reading start instruction from the user. That is, the second reading mode is a reading mode in which a re-read job is not accepted again after the reading job is ended.

The image reading device 31 is operable in any one of a plurality of output modes. The plurality of output modes includes a split output mode and a batch output mode. The split output mode is an output mode for generating plural pieces of file data respectively corresponding to a plurality of documents D read by the reading section 51.

The batch output mode is an output mode for generating a single piece of file data including a plurality of documents D read by the reading section 51. Specifically, the batch output mode is an output mode in which a plurality of documents D read by the reading section 51 are arranged in an arbitrary data order to generate one file data. The data order is the order in which the image data of the plurality of documents D are arranged.

### Reading mode setting process

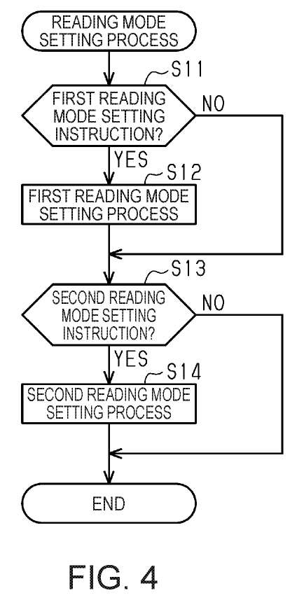

Here, the reading mode setting process will be described with reference to FIG. 4. The reading mode setting process is a process executed by the control section 90 at predetermined intervals when a reading job is not being executed. That is, the control section 90 executes the reading mode setting process.

As illustrated in FIG. 4, in step S11, the control section 90 determines whether or not a setting instruction of the first reading mode is input from the user. When the control section 90 determines that the setting instruction of the first reading mode is input, it proceeds to step S12. When the control section 90 determines that the setting instruction of the first reading mode is not input, it proceeds to step S13.

In step S12, the control section 90 executes a first reading mode setting process. In this process, the control section 90 sets the first reading mode data to the reading mode flag. The reading mode flag is assigned to the storage section 91. The reading mode flag is a flag that stores data indicating a reading mode. The first reading mode data is data indicating a first reading mode.

In step S13, the control section 90 determines whether or not a setting instruction of the second reading mode is input from the user. When the control section 90 determines that the setting instruction of the second reading mode is input, it proceeds to step S14. When the control section 90 determines that the setting instruction of the second reading mode is not input, the control section 90 ends the reading mode setting process.

In step S14, the control section 90 executes a second reading mode setting process. In this process, the control section 90 sets the second reading mode data to the reading mode flag. The second reading mode data is data indicating the second reading mode.

In this way, the control section 90 sets either the first reading mode or the second reading mode. That is, the control section 90 sets any one of a plurality of reading modes including the first reading mode and the second reading mode.

### Output mode setting process

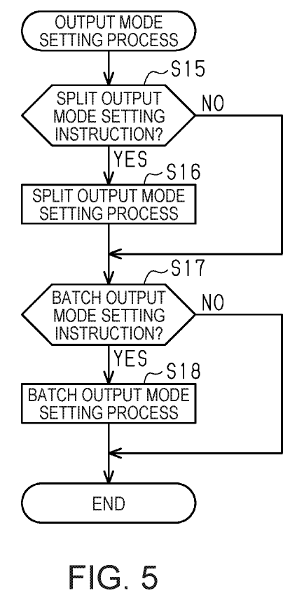

Next, the output mode setting process will be described with reference to FIG. 5. The output mode setting process is a process executed by the control section 90 at predetermined intervals when a reading job is not being executed. That is, the control section 90 executes the output mode setting process.

As illustrated in FIG. 5, in step S15, the control section 90 determines whether or not an instruction to set the split output mode has been input from the user. When the control section 90 determines that the setting instruction of the split output mode is input, it proceeds to step S16. When the control section 90 determines that the instruction to set the split output mode is not input, it proceeds to step S17.

In step S16, the control section 90 executes a split output mode setting process. In this process, the control section 90 sets the split output mode data to the output mode flag. The output mode flag is assigned to the storage section 91. The output mode flag is a flag that stores data indicating an output mode. The split output mode data is data indicating a split output mode.

In step S17, the control section 90 determines whether or not an instruction to set the batch output mode has been input by the user. When the control section 90 determines that the instruction to set the batch output mode is input, the control section 90 proceeds to step S18. When the control section 90 determines that the instruction to set the batch output mode is not input, the control section 90 ends the output mode setting process.

In step S18, the control section 90 executes a batch output mode setting process. In this process, the control section 90 sets the batch output mode data to the output mode flag. The batch output mode data is data indicating the batch output mode.

In this manner, the control section 90 sets either the split output mode or the batch output mode. That is, the control section 90 sets any one of a plurality of output modes including the split output mode and the batch output mode.

### Reading control process

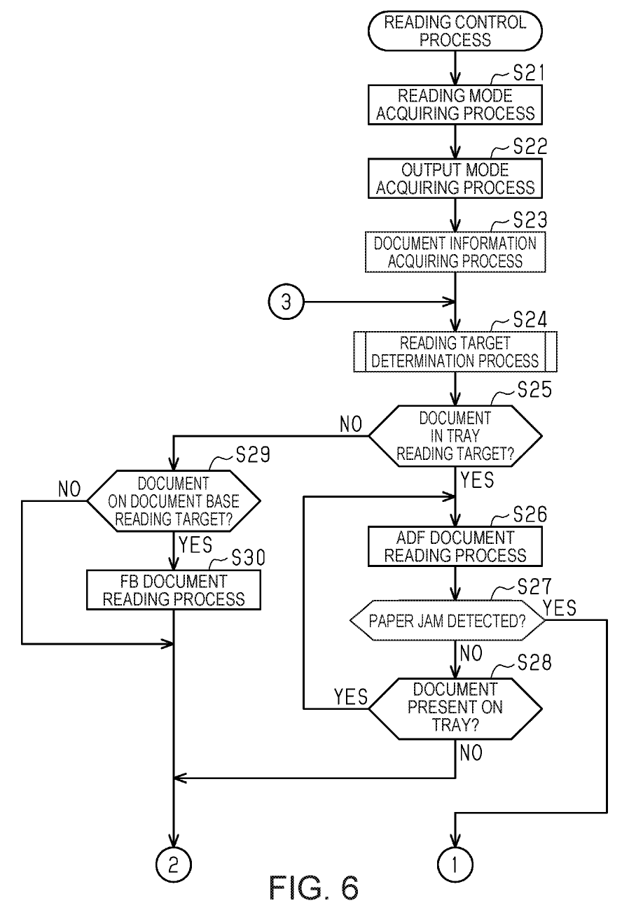

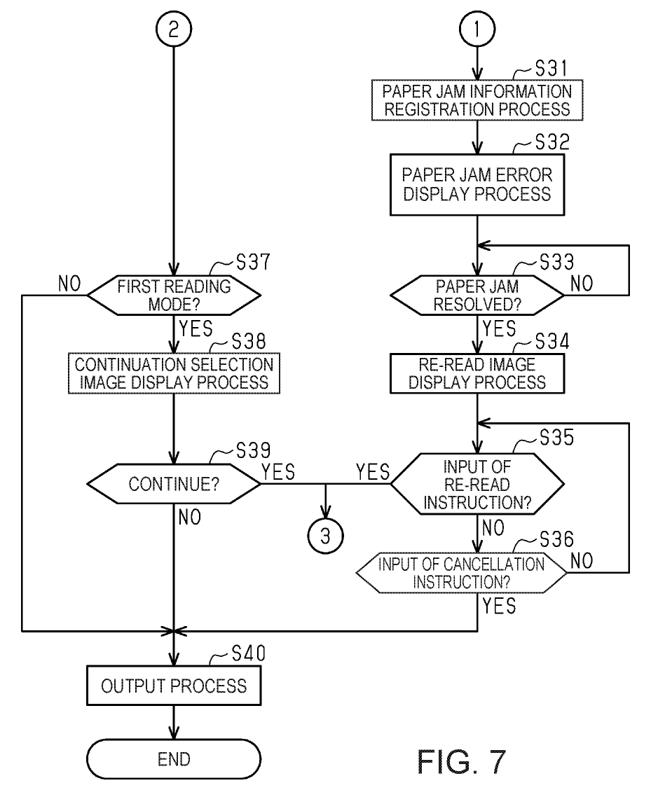

Next, the reading control process will be described with reference to FIGS. 6 and 7. The reading control process is a process executed by the control section 90 when the reading start instruction is input.

As illustrated in FIG. 6, in step S21, the control section 90 executes a reading mode acquiring process. In this process, the control section 90 acquires the reading mode flag set in the reading mode flag in steps S12 and S14.

In step S22, the control section 90 executes an output mode acquiring process. In this process, the control section 90 acquires the output mode based on the output mode flag set in steps S16 and S18.

In step S23, the control section 90 executes a document information acquiring process. In this process, the control section 90 acquires the size of the document D and the orientation of the document D included in the input reading start instruction as document information.

In step S24, the control section 90 executes a reading target determination process. In this process, the control section 90 determines whether the document D placed on the sheet feed tray 35 or the document D placed on the document base 33 is to be the reading target.

### Reading target determination process

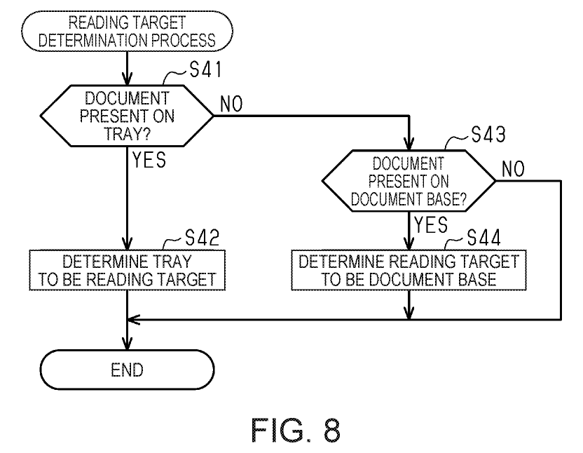

Here, the reading target determination process will be described with reference to FIG. 8. The reading target determination process is a process executed by the control section 90 in step S24 of the reading control process in FIG. 6.

As illustrated in FIG. 8, in step S41, the control section 90 determines whether or not there is a document D on the sheet feed tray 35 based on the detection signal from the document detection section 53. When the control section 90 determines that there is a document D on the sheet feed tray 35, it proceeds to step S42. When the control section 90 determines that there is no document D on the sheet feed tray 35, it proceeds to step S43.

In step S42, the control section 90 determines the document D transported from the sheet feed tray 35 as the reading target. The control section 90 stores data indicating that the document D transported from the sheet feed tray 35 is the reading target in the storage section 91. In this way, when the document detection section 53 detects the document D placed on the sheet feed tray 35, the control section 90 determines that the document D placed on the sheet feed tray 35 is the reading target.

In step S43, the control section 90 determines whether or not the document D is present on the document base 33 based on the image read by the reading section 51. That is, when the document detection section 53 does not detect the document D placed on the sheet feed tray 35, the control section 90 determines whether or not the document D placed on the document base 33 is the reading target. When the control section 90 determines that the document D is present on the document base 33, it proceeds to step S44. When the control section 90 determines that there is no document D on the document base 33, the control section 90 ends the reading target determination process.

In step S44, the control section 90 determines that the document D placed on the document base 33 is the reading target. The control section 90 stores data indicating that the reading target is the document D on the document base 33 in the storage section 91. As described above, when the document detection section 53 does not detect the document D placed on the sheet feed tray 35 and the reading section 51 detects the document D placed on the document base 33, the control section 90 determines that the document D placed on the document base 33 is the reading target.

In the present embodiment, when the control section 90 determines that there is no document D on both the sheet feed tray 35 and the document base 33, the control section 90 may store data indicating that there is no reading target in the storage section 91.

### Reading control process

As illustrated in FIG. 6, returning to the description of the reading control process, in step S25, the control section 90 determines whether or not the document D placed on the sheet feed tray 35 is the reading target based on the information indicating the reading target stored in the storage section 91. When the control section 90 determines that the document D placed on the sheet feed tray 35 is the reading target, it proceeds to step S26. When the control section 90 determines that the document D placed on the sheet feed tray 35 is not the reading target, it proceeds to step S29.

In step S29, the control section 90 determines whether or not the document D placed on the document base 33 is the reading target based on the information indicating the reading target stored in the storage section 91. When the control section 90 determines that the document D placed on the document base 33 is the reading target, it proceeds to step S30. When the control section 90 determines that the document D placed on the document base 33 is not the reading target, it proceeds to step S37 in FIG. 7.

In step S30, the control section 90 executes the FB document reading process. In this process, the control section 90 controls the reading section 51 to capture the document D placed on the document base 33.

In step S26, the control section 90 executes an ADF document reading process. In this process, the control section 90 controls the transport section 52 so as to transport the document D placed on the sheet feed tray 35 along the transport path. The control section 90 controls the reading section 51 to capture the document D transported by the transport section 52. The FB document reading process and the ADF document reading process correspond to an example of a document reading process for causing the reading section 51 to capture the document D.

In step S27, the control section 90 determines whether or not a paper jam of the document D transported by the transport section 52 has been detected based on the detection signal from the paper jam detection section 54. That is, the control section 90 determines the paper jam of the document D by the paper jam detection section 54 detecting the paper jam of the document D transported from the sheet feed tray 35 by the transport section 52. The process executed by the control section 90 corresponds to an example of a paper jam determination process.

When the control section 90 determines that a paper jam is not detected, it proceeds to step S28. When the control section 90 determines that a paper jam has been detected, the control section 90 proceeds to step S31 in FIG. 7.

In step S28, the control section 90 determines whether or not there is a document D on the sheet feed tray 35 based on the detection signal from the document detection section 53. When the control section 90 determines that there is a document D on the sheet feed tray 35, it proceeds to step S26 again. When the control section 90 determines that there is no document D on the sheet feed tray 35, it proceeds to step S37 in FIG. 7. In this manner, the control section 90 controls the reading section 51 to read one or a plurality of documents D placed on the sheet feed tray 35.

As illustrated in FIG. 7, in step S31, control section 90 performs a paper jam information registration process. In this process, control section 90 stores the result of the paper jam detection for document D, detected by the paper jam detection section 54, in the storage section 91 as paper jam information. Specifically, the control section 90 stores a paper jam history as the paper jam information in the storage section 91. The paper jam history is data that can identify that a paper jam has occurred. The control section 90 stores the paper jam order as the paper jam information in the storage section 91. The paper jam order is data that can identify the reading order of the document D in which the paper jam has occurred. That is, the paper jam information includes the paper jam history and the paper jam order. The paper jam information may be initialized based on the input of the reading start instruction.

In step S32, the control section 90 executes a paper jam error display process. In this process, the control section 90 controls the display section 14 to display an image for notifying the user of a paper jam error.

In step S33, the control section 90 determines whether or not the paper jam has been resolved based on the detection signal from the paper jam detection section 54. When the control section 90 determines that the paper jam has not been resolved, it returns to step S33 again. When the control section 90 determines that the paper jam has been resolved, it proceeds to step S34.

In step S34, the control section 90 executes a re-read image display process. In this process, the control section 90 controls the display section 14 to display the re-read image. As described above, when the paper jam of the document D is resolved after the paper jam of the document D is determined in the paper jam determination process, the control section 90 displays the re-read image on the display section 14.

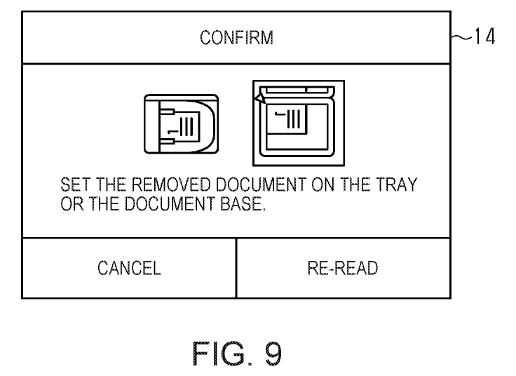

As illustrated in FIG. 9, the re-read image is an image that prompts the user to re-read the document D. The re-read image may be an image that prompts the user to re-read the document D including the document D in which the paper jam occurred.

The re-read image includes an image for prompting the user to re-read the document D that had the paper jam. The re-read image includes an image prompting the user to place the document D that had the paper jam on the sheet feed tray 35 or the document base 33. In particular, the re-read image includes an image that enables identification of the placement orientation in which the document D in which the paper jam has occurred is placed. That is, the re-read image includes an image that enables identification of the placement orientation of the document D placed on the sheet feed tray 35 and the placement orientation of the document D placed on the document base 33. In this manner, the control section 90 causes the display section 14 to display an image indicating the placement orientation of the document D placed on the sheet feed tray 35 and the placement orientation of the document D placed on the document base 33. The placement orientation of document D may refer to at least one of placing the document D in a vertical orientation or horizontal orientation and whether the placed document is in a top-bottom direction and a left-right direction.

The re-read image includes a cancellation instruction image and a re-read instruction image. When the cancellation instruction image is designated by the user, the cancellation instruction is input. The cancellation instruction is an instruction to cancel the re-reading of the document D. When the re-read instruction image is designated by the user, the re-read instruction is input. The re-read instruction is an instruction to re-read the document D.

In step S35 of FIG. 7, the control section 90 determines whether or not the re-read instruction is input. When the control section 90 determines that the re-read instruction is input, it returns to step S24 again. When the control section 90 determines that the re-read instruction is not input, it proceeds to step S36.

As described above, when the paper jam of the document D is resolved after the paper jam of the document D is determined in the paper jam determination process, the control section 90 causes the document reading process to be executed again based on the re-read instruction from the user.

In step S36, the control section 90 determines whether or not a cancellation instruction has been input. When the control section 90 determines that the cancellation instruction is not input, it returns the processing to step S35 again. When the control section 90 determines that the cancellation instruction is input, it proceeds to step S40. As described above, when a paper jam of a document D is determined in the paper jam determination process and the paper jam is subsequently resolved, the control section 90 executes a process that cancels the document reading process based on a cancellation instruction from the user.

In step S37, the control section 90 determines whether the current reading mode is the first reading mode based on the reading mode data set in the reading mode flag. When the control section 90 determines that the current reading mode is the first reading mode, it proceeds to step S38. When the control section 90 determines that the current reading mode is not the first reading mode, it proceeds to step S40.

In step S38, the control section 90 executes a continuation selection image display process. In this process, the control section 90 controls the display section 14 to display the continuation selection image. The continuation selection image is an image that enables a reading continuation instruction to be received from the user. The continuation selection image is an image for selecting whether or not to continue reading the document D.

In step S39, the control section 90 determines whether or not to continue reading the document D based on whether or not a reading continuation instruction is received from the user. When the reading continuation instruction is received from the user, the control section 90 determines to continue reading the document D. When the control section 90 determines to continue reading the document D, it returns to step S24. When the control section 90 determines not to continue reading the document D, it proceeds to step S40.

In step S40, the control section 90 executes an output process. In this process, the control section 90 reads the output mode data from the output mode flag. The control section 90 generates file data in an output format corresponding to the output mode data.

Specifically, when the output mode is the split output mode, the control section 90 generates plural pieces of file data corresponding to the plurality of documents D captured by the reading section 51. When the output mode is the batch output mode, the control section 90 generates a single piece of file data including the plurality of documents D captured by the reading section 51.

The control section 90 stores the generated file data in the storage section 91. In this manner, the control section 90 outputs the file data based on the output mode set in the output mode setting process.

Here, in a state where five documents D are placed on the sheet feed tray 35, a specific example of a case where a paper jam of the third document D occurs when the reading start instruction is input will be described. In such a case, the third document D is taken out from the transport path, and the paper jam is resolved. The third document D is placed again on the uppermost position of the sheet feed tray 35. By this, the third to fifth documents D are placed on the sheet feed tray 35. In this state, when a re-read instruction is input, the third to fifth documents D placed on the sheet feed tray 35 are sequentially captured.

As described above, in the reading control process, when the paper jam of the document D is resolved after the paper jam of the document D is determined, the control section 90 can execute the document reading process again based on the re-read instruction from the user. In particular, the control section 90 causes the reading section 51 to capture the document D determined as the reading target in the reading target determination process based on the reading start instruction from the user and the re-read instruction from the user. In the reading control process, the control section 90 executes the document reading process in the same manner in both a case where the document reading process is executed based on the reading start instruction and a case where the document reading process is executed again based on the re-read instruction.

The control section 90 executes the reading target determination process in the same manner in both a case where the document reading process is executed based on the reading start instruction and a case where the document reading process is executed again based on the re-read instruction. That is, the control section 90 determines the document D placed on the sheet feed tray 35 as the reading target in preference to the document D placed on the document base 33, regardless of whether there is a paper jam history.

Specifically, the control section 90 determines that document D on the sheet feed tray 35 is the reading target when the document detection section 53 detects it on the sheet feed tray 35, either in response to a reading start instruction or a re-read instruction. The control section 90 determines whether or not the document D placed on the document base 33 is the reading target when the document detection section 53 does not detect the document D placed on the sheet feed tray 35 in both the case based on the reading start instruction and the case based on the re-read instruction.

In the reading control process, the control section 90 does not change the reading mode. By this, the reading mode acquired in step S21 with the input of the reading start instruction from the user as a trigger is continued even after the paper jam of the document D is determined in the paper jam determination process of step S27. That is, the reading mode set in steps S12 and S14 is continued after the paper jam of the document D is determined in the paper jam determination process of step S27.

In the reading control process, the control section 90 does not change the output mode. By this, the output mode acquired in step S22 with the input of the reading start instruction from the user as a trigger is continued even after the paper jam of the document D is determined in the paper jam determination process of step S27. That is, the output mode set in steps S16 and S18 continues after document D is determined to be jammed in the paper jam determination process of step S27.

### Operation and effects of the first embodiment

The operation and effects of the first embodiment will be described.

(1-1) The reading mode set in the reading mode setting process illustrated in FIG. 4 is continued after the paper jam of the document D is determined. By this, even in a case where the paper jam of the document D is resolved after the paper jam of the document D is determined, the reading mode is continued as intended by the user. Therefore, it is possible to improve user convenience.

(1-2) When the document detection section 53 detects the document D placed on the sheet feed tray 35, the control section 90 determines that the document D placed on the sheet feed tray 35 is reading target. When the document detection section 53 does not detect the document D placed on the sheet feed tray 35, the control section 90 determines whether or not the document D placed on the document base 33 is reading target. By this, both when reading of document D is initiated based on a reading start instruction and when re-reading is initiated based on a re-read instruction, the system can prioritize reading the document D placed on the sheet feed tray 35 over the document D placed on the document base 33. Therefore, even when the paper jam of the document D is resolved after the paper jam of the document D is determined, the priority order of the document D placed on the document base 33 and the document D placed on the sheet feed tray 35 is not changed. Therefore, it is possible to improve user convenience.

(1-3) The output mode set in the output mode setting process illustrated in FIG. 5 is continued after the paper jam of the document D is determined. According to this configuration, even when the paper jam of the document D is resolved after the paper jam of the document D is determined, the output mode is continued as intended by the user. Therefore, it is possible to improve user convenience.

(1-4) When the paper jam of a document D is determined in the paper jam determination process and the paper jam is subsequently resolved, the control section 90 executes, a process that cancels the document reading process based on a cancellation instruction from the user. By this, even when the paper jam of the document D is resolved, the re-reading of the document D can be canceled as intended by the user. Therefore, it is possible to improve user convenience.

(1-5) When the paper jam of the document D is resolved after the paper jam of the document D is determined, the control section 90 causes the display section 14 to display an image indicating either the placement orientation of the document D placed on the sheet feed tray 35 or the placement orientation of the document D placed on the document base 33. By this, it allows the user to visually confirm either the placement orientations of document D on the sheet feed tray 35 or on the document base 33. Therefore, it is possible to improve user convenience.

### Second Embodiment

Next, a second embodiment will be described. In the following description, redundant descriptions of configurations identical to those of the previously described embodiment will be omitted or simplified, and configurations that differ from the previously described embodiment will be detailed.

In the second embodiment, the control section 90 may determine the document D placed on the document base 33 as the reading target in preference to the document D placed on the sheet feed tray 35, when there is a paper jam history.

### Reading target determination process

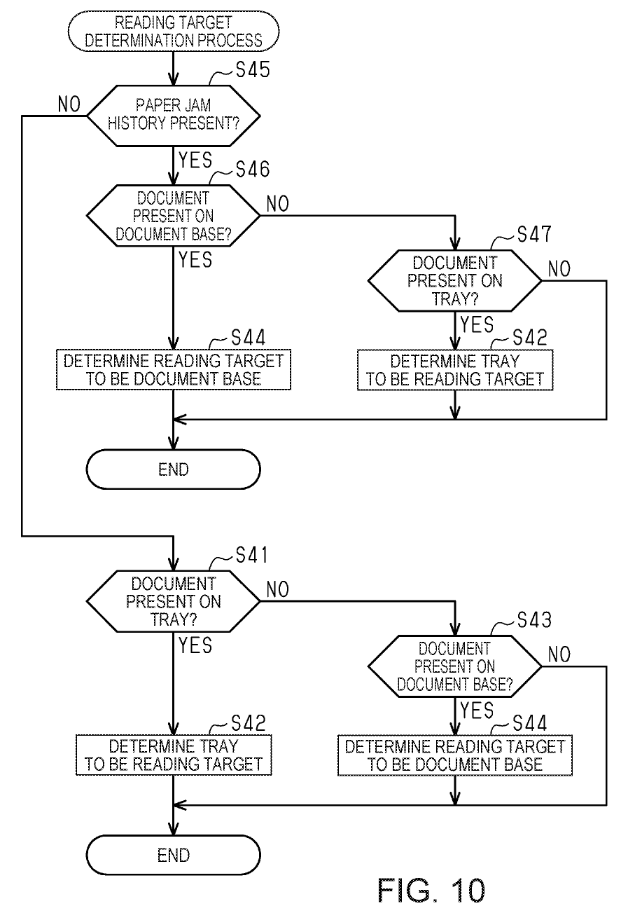

As illustrated in FIG. 10, in step S45, the control section 90 determines whether or not there is a paper jam history of the document D in the storage section 91. When the control section 90 determines that there is a paper jam history of the document D in the storage section 91, it proceeds to step S46. When the control section 90 determines that there is no paper jam history of the document D in the storage section 91, it proceeds to step S41.

In step S46, the control section 90 determines whether or not there is a document D on the document base 33. When the control section 90 determines that the document D is present on the document base 33, it proceeds to step S44. When the control section 90 determines that there is no document D on the document base 33, it proceeds to step S47.

In step S47, the control section 90 determines whether or not there is a document D on the sheet feed tray 35. When the control section 90 determines that there is a document D on the sheet feed tray 35, it proceeds to step S42. When the control section 90 determines that there is no document D on the sheet feed tray 35, the control section 90 ends the reading target determination process.

As described above, when the document reading process is executed again based on the re-read instruction, the control section 90 determines that the document D placed on the document base 33 is the reading target when the reading section 51 detects the document D placed on the document base 33 in the reading target determination process. Further, when the reading section 51 does not detect the document D placed on the document base 33 in the reading target determination process, the control section 90 determines whether or not the document D placed on the sheet feed tray 35 is set as the reading target.

### Operations and effects of second embodiment

Operations and effects of the second embodiment will be described.

(2-1) In a case where the document reading process is executed again based on the re-read instruction, when the reading section 51 detects the document D placed on the document base 33, the control section 90 determines that the document D placed on the document base 33 is the reading target. When the reading section 51 does not detect the document D placed on the document base 33, the control section 90 determines whether or not the document D placed on the sheet feed tray 35 is reading target. According to this configuration, when a paper jam occurs with the document D transported from the sheet feed tray 35 and is subsequently resolved, it can prioritize reading the document D placed on the document base 33 over the document D placed on the sheet feed tray 35. By this, the user can avoid the occurrence of a paper jam again when the user causes the reading section 51 to capture the document D that has caused the paper jam again. Therefore, the reliability of re-reading of the document D can be improved. Therefore, it is possible to improve user convenience.

(2-2) In a case where the document reading process is executed based on the reading start instruction, when the document detection section 53 detects the document D placed on the sheet feed tray 35, the control section 90 determines that the document D placed on the sheet feed tray 35 is the reading target. When the document detection section 53 does not detect the document D placed on the sheet feed tray 35, the control section 90 determines whether or not the document D placed on the document base 33 is reading target. According to this configuration, when a paper jam involving document D is determined and subsequently resolved, it can change the reading priority order to favor the document D placed on the document base 33 over the document D placed on the sheet feed tray 35. Therefore, it is possible to improve user convenience.

### Third Embodiment

Next, a third embodiment will be described.

In the third embodiment, the control section 90 may change the data order of the jammed document based on the order change instruction from the user. The jammed document refers to document D, which experienced a paper jam and is to be re-read. The order change instruction is an instruction to change the data order of the jammed document by the user.

### Second reading control process

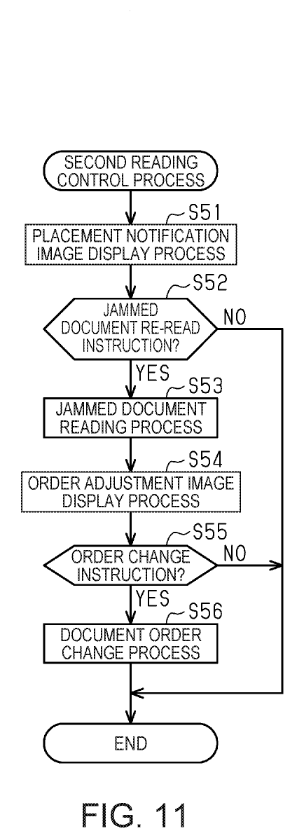

As illustrated in FIG. 11, the control section 90 is configured to execute a second reading control process. The second reading control process is a process executed by the control section 90 immediately before step S40 of the reading control process of FIG. 7 when there is a paper jam history in the case where the output mode is the batch output mode.

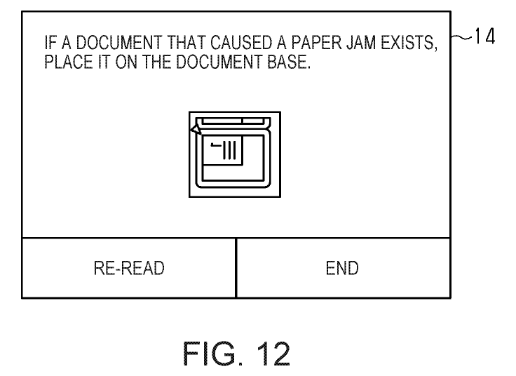

In step S51, the control section 90 executes a placement notification image display process. In this process, the control section 90 controls the display section 14 to display the placement notification image illustrated in FIG. 12 on the display section 14.

As illustrated in FIG. 12, the placement notification image is an image for prompting the user to place the document D that experienced a paper jam when the document D that experienced a paper jam is re-read. The placement notification image may be an image prompting the user to place the document D that experienced a paper jam on the document base 33.

The placement notification image may include a re-read instruction image, similarly to the re-read image. The placement notification image may include a completion instruction image. When the completion instruction image is designated by the user, the completion instruction is input. The completion instruction is an instruction not to re-read the jammed document.

In step S52 of FIG. 11, the control section 90 determines whether or not the instruction is a re-read instruction for a jammed document. When the control section 90 determines that the instruction is the re-read instruction for the jammed document, it proceeds to step S53. When the control section 90 determines that the instruction is not the re-read instruction for the jammed document, it ends the second reading control process. That is, control section 90 terminates the second reading control process when it determines that the instruction is a completion instruction for a jammed document.

In step S53, the control section 90 executes a jammed document reading process. In this process, the control section 90 controls the reading section 51 to read the jammed document. In this manner, the document D read by the reading section 51 can be identified as a jammed document. The jammed document reading process is an example of a document reading process.

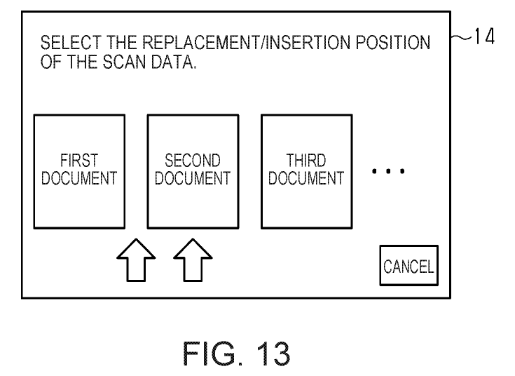

In step S54, the control section 90 executes an order adjustment image display process. In this process, the control section 90 controls the display section 14 to display the order adjustment image illustrated in FIG. 13 on the display section 14.

As illustrated in FIG. 13, the order adjustment image is an image for adjusting the data order of the jammed document. The order adjustment image is an image in which the documents D excluding the jammed document are displayed in the reading order. The order adjustment image includes an instruction image for designating the data order of the jammed document. The instruction image can instruct an insertion order of a jammed document. The instruction image can instruct the document D to replace the jammed document among the documents D excluding the jammed document. When the user designates the instruction image, the order change instruction is input. The order adjustment image may include a cancellation instruction image.

In step S55 of FIG. 11, the control section 90 determines whether or not there is the order change instruction. If control section 90 determines that the instruction is the order change instruction, it proceeds to step S56. If control section 90 determines that the instruction is not the order change instruction, it terminates the second reading control process. That is, if the control section 90 determines that the instruction is the cancellation instruction, it terminates the second reading control process.

In step S56, the control section 90 executes the document order change process. In this process, the control section 90 changes the data order of the jammed document based on the order change instruction from the user.

Specifically, in the case of the order change instruction indicating the insertion order of the jammed document, the control section 90 changes the data order of the jammed document so as to insert the jammed document in the order corresponding to the insertion order. The jammed document can be inserted in the data order between the head of the document D other than the jammed document and the document D other than the jammed document, but may be inserted in the data order of the last document D other than the jammed document.

When the instruction is an order change instruction to replace the order of a jammed document, the control section 90 changes the data order of the jammed document so that document D, which is the replacement target for the jammed document, is replaced with the jammed document. In this case, the control section 90 deletes the data of document D to be replaced.

In this manner, the control section 90 causes the reading section 51 to read the plurality of documents D including the jammed document by executing the document reading processing again based on the re-read instruction. In this case, the control section 90 changes the data order of the jammed document as the data order of the plurality of documents D included in one file data.

### Operations and effects of third embodiment

Operations and effects of a third embodiment will be described.

(3-1) When the control section 90 causes the reading section 51 to read the jammed document by executing the document reading process again based on the re-read instruction, the control section 90 can change the data order of the jammed document as the data order of the plurality of documents D. According to this configuration, the data order of the jammed document can be changed after the jammed document is read again. Therefore, it is possible to improve user convenience.

(3-2) The control section 90 changes the data order of the jammed document based on the order change instruction from the user. By this, the user can change the data order of the jammed document as intended. Specifically, the data of the jammed document can be inserted or replaced at a position designated by the user. Therefore, it is possible to improve user convenience.

### Fourth Embodiment

Next, a fourth embodiment will be described.

In the fourth embodiment, the control section 90 may change the data order of the jammed document to the paper jam order stored in the storage section 91.

### Second reading control process

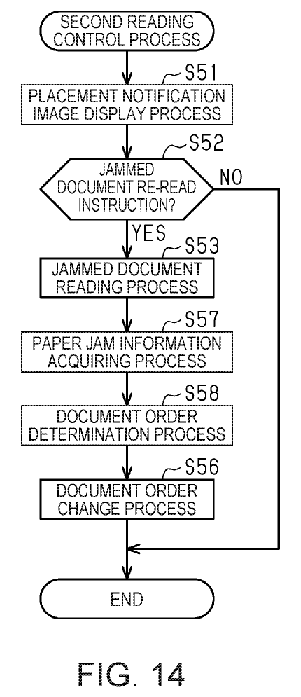

As illustrated in FIG. 14, once step S53 is completed, the control section 90 proceeds to step S57. In step S57, the control section 90 performs a paper jam information acquiring process. In this process, the control section 90 reads the paper jam order from the storage section 91 as the paper jam information. By this, the control section 90 acquires the paper jam order.

In step S58, the control section 90 executes a document order determination process. In this process, the control section 90 determines the data order of the jammed document based on the acquired paper jam information.

Specifically, the control section 90 acquires the reading order in which the paper jam has occurred based on the paper jam order. The control section 90 determines the reading order in which the paper jam has occurred as the data order of the jammed document.

In particular, when an abnormal document D is read as the reading order in which the paper jam has occurred, the control section 90 determines the data order of the jammed document so as to replace the abnormal document D with the jammed document. When the abnormal document D is not read in the reading order in which the paper jam has occurred, the control section 90 determines the data order of the jammed document so that the jammed document is inserted in the reading order in which the paper jam has occurred.

In step S56, the control section 90 changes the data order as determined in step S58. In this way, the control section 90 changes the data order of the jammed document to the paper jam order stored in the storage section 91.

### Operations and effects of fourth embodiment

Operations and effects of a fourth embodiment will be described.

(4-1) When the control section 90 determines that a paper jam of the document D has occurred, it stores the reading order of the document D in which the paper jam has occurred in the storage section 91 as the paper jam order. The control section 90 changes the data order of the jammed document to the paper jam order stored in the storage section 91. By this, it can change the data order of the jammed document to the paper jam order stored in the storage section 91. Therefore, it is possible to improve user convenience.

### Fifth Embodiment

Next, a fifth embodiment will be described.

In the fifth embodiment, the control section 90 may change the order of the jammed document based on the similarity between the jammed document and the document D other than the jammed document.

### Second reading control process

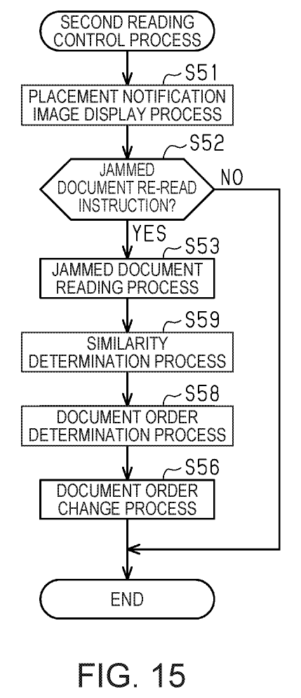

As illustrated in FIG. 15, when step S53 is completed, the control section 90 proceeds to step S59.

In step S59, the control section 90 executes a similarity determination process. In this process, the control section 90 calculates the similarity between the image data of the jammed document and the image data of the documents D other than the jammed document. The similarity is data obtained by quantifying whether two pieces of image data to be compared are similar to each other. The similarity is a high numerical value when two pieces of image data to be compared are similar. The control section 90 determines the data order of the jammed document so that the document D having the highest similarity to the jammed document is replaced with the jammed document.

When a paper jam occurs, document D other than the jammed document may include an abnormal document. The abnormal document D may contain portions of the jammed document that have been read correctly. Therefore, the degree of similarity between the jammed document and the abnormal document D tends to be high.

In this manner, the control section 90 changes the data order of the jammed document by replacing the jammed document with the document D determined to have a high similarity based on the similarity between the jammed document and the document D other than the jammed document.

### Operations and effects of fifth embodiment

Operations and effects of a fifth embodiment will be described.

(5-1) The control section 90 changes the data order of the jammed document in the document order change process by replacing the jammed document with the document D determined to have a high similarity among the plurality of documents D. By this, the data order of the jammed document can be changed by replacing the jammed document with the document D having a high similarity based on the similarity with the jammed document. Therefore, it is possible to improve user convenience.

### Modified examples

The present embodiment can be implemented with the following modifications. The present embodiments and the following modifications can be implemented in combination with each other as long as there is no technical contradiction.

In the first embodiment, the re-read image may be an image that prompts the user to place a jammed document on the uppermost position of the sheet feed tray 35. The re-read image may include a switching instruction image for switching the document D placed on the document base 33 to the reading target. When the switching instruction image is designated by the user, the control section 90 may switch the document D placed on the document base 33 to the reading target by inputting the switching instruction.

In the second embodiment, the re-read image may be an image prompting the user to place a jammed document on the document base 33. The re-read image may include a switching instruction image for switching the document D placed on the sheet feed tray 35 to the reading target. When the switching instruction image is designated by the user, the control section 90 may switch the document D placed on the sheet feed tray 35 to the reading target by inputting the switching instruction.

In the first embodiment and the second embodiment, when the re-read instruction is input, the control section 90 may identify the document D read first as the jammed document based on the re-read instruction. In such a case, the control section 90 may control the data order of the identified jammed document as in the third embodiment, the fourth embodiment, and the fifth embodiment.

After the paper jam is resolved, the control section 90 may cause the display section 14 to display an image prompting the user to give an instruction as to whether or not the document D is a jammed document, regardless of the reading order of the document D. After the paper jam is resolved, the control section 90 may identify the jammed document according to an instruction from the user regardless of the reading order of the document D. In such a case, the control section 90 may control the data order of the identified jammed document as in the third embodiment, the fourth embodiment, and the fifth embodiment.

In the fifth embodiment, the control section 90 may determine the data order of the jammed document so that the document D having the highest similarity to the jammed document among the documents D having the similarity to the jammed document higher than the threshold value is replaced with the jammed document. When there is no document D having a similarity to the jammed document higher than the threshold value, the control section 90 may not change the data order of the jammed document.

In the fifth embodiment, the control section 90 may calculate the degree of difference from the image data of the jammed document for each of the image data of the documents D other than the jammed document. The degree of difference is data obtained by quantifying whether two pieces of image data to be compared are different from each other. The degree of difference is a low numerical value when two pieces of image data to be compared are similar. The control section 90 may determine the data order of the jammed document so that the document D having the lowest degree of difference from the jammed document is replaced with the jammed document.

The control section 90 may calculate the placement orientation of the document D based on the document D read by the reading section 51. By this, the control section 90 may display the re-read image on the display section 14.

The re-read image may include the size of the document D placed on the sheet feed tray 35 and the size of the document D placed on the document base 33. The re-read image may not include the placement orientation of the document D placed on the sheet feed tray 35 and the placement orientation of the document D placed on the document base 33. That is, the re-read image may include an image indicating at least one of the size of the document D placed on the sheet feed tray 35, the placement orientation of the document D placed on the sheet feed tray 35, the size of the document D placed on the document base 33, and the placement orientation of the document D placed on the document base 33. By this, the control section 90 causes the display section 14 to display an image indicating at least one of the size of the document D and the placement orientation of the document D placed on the sheet feed tray 35 and the size of the document D and the placement orientation of the document D placed on the document base 33.

The plurality of reading modes may include a reading mode different from the first reading mode and the second reading mode. The plurality of output modes may include an output mode different from the split output mode and the batch output mode.

The image reading device 31 may include a plurality of reading section 51. The image reading device 31 may include a first reading section that reads the front side of the document D transported from the sheet feed tray 35, and a second reading section that reads the front side of the document D transported from the sheet feed tray 35. The first reading section may be the reading section 51. The second reading section may be provided on the document base cover 34. The second reading section is provided downstream of the first reading section in the transport path, but may be provided upstream of the first reading section in the transport path. The image reading device 31 may include a first reading section that reads the document D transported from the sheet feed tray 35 and a second reading section that reads the document D placed on the document base 33.

The image reading device 31 may include a plurality of document detection sections 53. The image reading device 31 may include a plurality of paper jam detection sections 54. The plurality of paper jam detection sections 54 may be provided along the transport path. The image reading device 31 may include a second document detection section that detects the document D placed on the document base 33. The second document detection section may be provided separately from the reading section 51. In this case, the document detection section 53 may be the first document detection section.

The control section 90 may not execute the reading mode setting process at every predetermined cycle. The control section 90 may execute the reading mode setting process in response to the input of the reading start instruction, and acquire the reading mode in step S21 of FIG. 6.

The control section 90 does not have to execute the output mode setting process at predetermined intervals. The control section 90 may execute the output mode setting process in response to the input of the reading start instruction, and may acquire the output mode in step S22 of FIG. 6.

The image reading device 31 may receive the user's instruction in the operation section 15 without displaying the image for inputting the user's instruction in the display section 14. In this case, the display section 14 may not be a touch panel.

The image reading device 31 may not be mounted on the multifunction device 11. The multifunction device 11 may not include the printing device 21. That is, the multifunction device 11 may be the image reading device 31 that does not include the printing device 21.

As used herein, the phrase "at least any" means one or more of the desired options. As an example, the phrase "at least any of" as used herein means only one option if the number of options is two, or both of the two options. As another example, the phrase "at least any" as used herein means only one option or a combination of any two or more options if the number of options is three or more.

### Supplementary notes

Hereinafter, technical ideas grasped from the above-described embodiment and modifications, and operational effects thereof will be described. The present technical idea and the operational effects thereof can be combined with each other within a technically consistent range.

An image reading device includes a sheet feed tray on which a document is placed; a transport section configured to transport the document from the sheet feed tray; a document base on which the document is placed; a reading section configured to read the document; and a control section, wherein the control section executes a reading mode setting process that sets one of a plurality of reading modes, the reading modes including a first reading mode in which a reading continuation instruction is receivable from a user after the reading section has read the document and a second reading mode in which a reading continuation instruction is not accepted from the user after the reading section has read the document, a reading target determination process for determining whether a document placed on the sheet feed tray is a reading target or a document placed on the document base is the reading target, a document reading process for, based on a reading start instruction from a user, causing the reading section to read the document that was determined to be the reading target in the reading target determination process, and a paper jam determination process for determining a paper jam of the document transported from the sheet feed tray by the transport section, when a paper jam of a document is determined in the paper jam determination process and the paper jam of the document is subsequently resolved, the document reading process is executable again based on a re-read instruction from a user, and the reading mode set in the reading mode setting process is maintained after the paper jam of the document is determined in the paper jam determination process.

According to this configuration, even when the paper jam of the document is resolved after the paper jam of the document is determined in the paper jam determination process, the reading mode is continued as intended by the user. Therefore, it is possible to improve user convenience.

The above described image reading device further includes a document detection section configured to detect a document placed on the sheet feed tray, wherein the control section both when the document reading process is executed based on the reading start instruction and when the document reading process is re-executed based on the re-read instruction, determines in the reading target determination process that a document placed on the sheet feed tray is the reading target if the document detection section detects the document placed on the sheet feed tray and determines in the reading target determination process whether the document placed on the document base is the reading target if the document detection section does not detect a document placed on the sheet feed tray.

According to this configuration, it is possible to prioritize reading the document placed on the sheet feed tray over the document placed on the document base, both when reading document is started based on the reading start instruction and when re-reading is started based on a re-read instruction. Therefore, even when the paper jam of the document is resolved after the paper jam of the document is determined in the paper jam determination process, the priority order of the document placed on the document base and the document placed on the sheet feed tray is not changed. Therefore, it is possible to improve user convenience.

The above described image reading device is configured such that, the reading section is configured to detect a document placed on the document base and the control section when re-executing the document reading process based on the re-read instruction, determines in the reading target determination process that the document placed on the document base is the reading target if the reading section detects a document placed on the document base and determines in the reading target determination process whether or not the document placed on the sheet feed tray is the reading target if the reading section does not detect a document placed on the document base.

According to this configuration, when a paper jam of a document occurs with a document transported from the sheet feed tray and the jam of the paper document is subsequently resolved, the system can prioritize reading the document placed on the document base over the document placed on the sheet feed tray. By this, the reliability of document re-reading can be improved. Therefore, it is possible to improve user convenience.

The above described image reading device further includes a document detection section configured to detect a document placed on the sheet feed tray, wherein the control section when executing the document reading process based on the reading start instruction, determines in the reading target determination process that a document placed on the sheet feed tray is the reading target if the document detection section detects a document placed on the sheet feed tray and determines in the reading target determination process whether the document placed on the document base is the reading target if the document detection section does not detect a document placed on the sheet feed tray.

According to this configuration, in the paper jam determination process, when a paper jam of a document is determined and the paper jam of the document is subsequently resolved, it can change the reading priority order to favor the document placed on the document base over the document placed on the sheet feed tray. Therefore, it is possible to improve user convenience.

The image reading device described above is configured such that, the control section executes an output mode setting process that sets one of a plurality of output modes, the output modes including a split output mode in which plural pieces of file data are generated respectively for plural documents read by the reading section and a batch output mode in which one piece of file data is generated including plural documents read by the reading section and an output process for outputting file data based on the output mode set in the output mode setting process and the output mode set in the output mode setting process is maintained after the paper jam of the document is determined in the paper jam determination process.

According to the present configuration, even when the paper jam of the document is resolved subsequent to a paper jam of a document be determined in the paper jam determination process, the output mode is maintained in accordance with the user's original intention. Therefore, it is possible to improve user convenience.

The above described image reading device such that, the control section is configured to, in the case of generating a single piece of file data including plural documents read by the reading section when causing the reading section to read plural documents including a jammed document by the document reading process being re-executed based on a re-read instruction, execute a document order change process that changes data order of the jammed document as the data order of plural documents included in a single piece of file data.

According to this configuration, the data order of the jammed document can be changed after the jammed document is read again. Therefore, it is possible to improve user convenience.

The image reading device described above is configured such that, the control section, during the document order change process, changes the data order of the jammed document based on an order change instruction provided by a user. According to this configuration, the data order of the jammed document can be changed as intended by the user. Therefore, it is possible to improve user convenience.

The image reading device described above is configured such that, the control section when a paper jam of a document is determined in the paper jam determination process, executes a paper jam information registration process in which the reading order of the jammed document is stored in the storage section as a paper jam order and in the document order change process, changes the data order of the jammed document to the paper jam order stored in the storage section. According to this configuration, the data order of the jammed document can be changed to the paper jam order stored in the storage section. Therefore, it is possible to improve user convenience.

The image reading device described above is configured such that, the control section executes a similarity determination process that determines degree of similarity among plural documents included in the single piece of file data and changes data order of the jammed document in the document order change process by replacing the jammed document with a document determined to have a high degree of similarity among the plural documents in the similarity determination process.

According to this configuration, the data order of the jammed document can be changed by replacing the jammed document with a document having a high similarity based on the similarity with the jammed document. Therefore, it is possible to improve user convenience.

The image reading device described above is configured such that, when a paper jam of a document is determined in the paper jam determination process and the paper jam of the document is subsequently resolved, the control section cancels the document reading process based on a cancellation instruction from the user.

According to this configuration, even when the paper jam of the document is resolved, the re-reading of the document can be stopped as intended by the user. Therefore, it is possible to improve user convenience.

The image reading device described above is configured such that, when a paper jam of a document is determined in the paper jam determination process and the paper jam of the document is subsequently resolved, the control section displays an image on a display section indicating at least one of sizes of the document placed on the sheet feed tray, placement orientation of the document placed on the sheet feed tray, size of a document placed on the document base, and placement orientation of the document placed on the document base.

According to this configuration, the user can confirm visually at least one of the size of the document placed on the sheet feed tray, the placement orientation of the document placed on the sheet feed tray, the size of the document placed on the document base, and the placement orientation of the document placed on the document base. Therefore, it is possible to improve user convenience.

An image reading device control method having a reading section configured to read either a document conveyed from a sheet feed tray or a document placed on a document base, the an image reading device control method includes a reading mode setting process that sets one of a plurality of reading modes, the reading modes including a first reading mode in which a reading continuation instruction is receivable from a user after the reading section has read the document and a second reading mode in which a reading continuation instruction is not accepted from the user after the reading section has read the document, a reading target determination process for determining whether a document placed on the sheet feed tray is a reading target or a document placed on the document base is the reading target, a document reading process for, based on a reading start instruction from a user, causing the reading section to read the document that was determined to be the reading target in the reading target determination process, and a paper jam determination process for determining a paper jam of the document transported from the sheet feed tray, the document reading process is a process that is re-executable in a case where a paper jam of a document is determined in the paper jam determination process and the paper jam of the document is subsequently resolved and the reading mode set in the reading mode setting process is maintained after the paper jam of the document is determined in the paper jam determination process. According to this configuration, the same effect as that of [1] can be achieved.

What is claimed is:

1. An image reading device comprising:
a sheet feed tray on which a document is placed;
a transport section configured to transport the document from the sheet feed tray;
a document base on which the document is placed;
a reading section configured to read the document; and
a control section, wherein
the control section executes
a reading mode setting process that sets one of a plurality of reading modes, the reading modes including
a first reading mode in which a reading continuation instruction is receivable from a user after the reading section has read the document and
a second reading mode in which a reading continuation instruction is not accepted from the user after the reading section has read the document,
a reading target determination process for determining whether a document placed on the sheet feed tray is a reading target or a document placed on the document base is the reading target,
a document reading process for, based on a reading start instruction from a user, causing the reading section to read the document that was determined to be the reading target in the reading target determination process, and
a paper jam determination process for determining a paper jam of the document transported from the sheet feed tray by the transport section,
when a paper jam of a document is determined in the paper jam determination process and the paper jam of the document is subsequently resolved, the document reading process is executable again based on a re-read instruction from a user, and
the reading mode set in the reading mode setting process is maintained after the paper jam of the document is determined in the paper jam determination process.

2. The image reading device according to claim 1, further comprising:
a document detection section configured to detect a document placed on the sheet feed tray, wherein
the control section
both when the document reading process is executed based on the reading start instruction and when the document reading process is re-executed based on the re-read instruction, determines in the reading target determination process that a document placed on the sheet feed tray is the reading target if the document detection section detects the document placed on the sheet feed tray and
determines in the reading target determination process whether the document placed on the document base is the reading target if the document detection section does not detect a document placed on the sheet feed tray.

3. The image reading device according to claim 1, wherein
the reading section is configured to detect a document placed on the document base and
the control section
when re-executing the document reading process based on the re-read instruction, determines in the reading target determination process that the document placed on the document base is the reading target if the reading section detects a document placed on the document base and
determines in the reading target determination process whether or not the document placed on the sheet feed tray is the reading target if the reading section does not detect a document placed on the document base.

4. The image reading device according to claim 3, further comprising:
a document detection section configured to detect a document placed on the sheet feed tray, wherein
the control section
when executing the document reading process based on the reading start instruction, determines in the reading target determination process that a document placed on the sheet feed tray is the reading target if the document detection section detects a document placed on the sheet feed tray and
determines in the reading target determination process whether the document placed on the document base is the reading target if the document detection section does not detect a document placed on the sheet feed tray.

5. The image reading device according to claim 1, wherein
the control section executes
an output mode setting process that sets one of a plurality of output modes, the output modes including a split output mode in which plural pieces of file data are generated respectively for plural documents read by the reading section and a batch output mode in which one piece of file data is generated including plural documents read by the reading section and
an output process for outputting file data based on the output mode set in the output mode setting process and
the output mode set in the output mode setting process is maintained after the paper jam of the document is determined in the paper jam determination process.

6. The image reading device according to claim 1, wherein
the control section is configured to, in the case of generating a single piece of file data including plural documents read by the reading section when causing the reading section to read plural documents including a jammed document by the document reading process being re-executed based on a re-read instruction, execute a document order change process that changes data order of the jammed document as the data order of plural documents included in a single piece of file data.

7. The image reading device according to claim 6, wherein
the control section, during the document order change process, changes the data order of the jammed document based on an order change instruction provided by a user.

8. The image reading device according to claim 6, wherein
the control section
when a paper jam of a document is determined in the paper jam determination process, executes a paper jam information registration process in which the reading order of the jammed document is stored in the storage section as a paper jam order and
in the document order change process, changes the data order of the jammed document to the paper jam order stored in the storage section.

9. The image reading device according to claim 6, wherein
the control section
executes a similarity determination process that determines degree of similarity among plural documents included in the single piece of file data and
changes data order of the jammed document in the document order change process by replacing the jammed document with a document determined to have a high degree of similarity among the plural documents in the similarity determination process.

10. The image reading device according to claim 1, wherein
when a paper jam of a document is determined in the paper jam determination process and the paper jam of the document is subsequently resolved, the control section cancels the document reading process based on a cancellation instruction from the user.

11. The image reading device according to claim 10, wherein
when a paper jam of a document is determined in the paper jam determination process and the paper jam of the document is subsequently resolved, the control section displays an image on a display section indicating at least one of sizes of the document placed on the sheet feed tray, placement orientation of the document placed on the sheet feed tray, size of a document placed on the document base, and placement orientation of the document placed on the document base.

12. An image reading device control method including a reading section configured to read either a document conveyed from a sheet feed tray or a document placed on a document base, the method comprising:
a reading mode setting process for selecting one of a plurality of reading modes, the reading modes including a first reading mode in which a reading continuation instruction is receivable from a user after the reading section has read the document and a second reading mode in which a reading continuation instruction is not accepted from the user after the reading section has read the document;
a reading target determination process for determining whether a document placed on the sheet feed tray is the reading target or a document placed on the document base is the reading target;
a document reading process for, based on a reading start instruction from a user, causing the reading section to read the document determined to be the reading target in the reading target determination process; and
a paper jam determination process for determining a paper jam of the document transported from the sheet feed tray, wherein
the document reading process is a process that is re-executable in a case where a paper jam of a document is determined in the paper jam determination process and the paper jam of the document is subsequently resolved and
the reading mode set in the reading mode setting process is maintained after the paper jam of the document is determined in the paper jam determination process.
